(19) United States
(12) Patent Application Publication
(10) Pub. No.: US 2011/0145783 A1
(43) Pub. Date: Jun. 16, 2011

(54) SYSTEM AND METHOD FOR REPRESENTING AND VALIDATING FUNCTIONAL REQUIREMENTS OF A SOFTWARE SYSTEM

(75) Inventors: Parameswaran Seshan, Bangalore (IN); Srinivas Thonse, Bangalore (IN)

(73) Assignee: INFOSYS TECHNOLOGIES LIMITED, Bangalore (IN)

(21) Appl. No.: 12/813,789

(22) Filed: Jun. 11, 2010

(30) Foreign Application Priority Data
Dec. 16, 2009 (IN) 3108/CHE/2009

(51) Int. Cl. G06F 9/44

(52) U.S. Cl. 717/105

(57) ABSTRACT

A method and system for representing and validating requirements of a software system is provided. The method includes capturing requirements of the software system. The method further includes converting the captured requirements into an executable business process definition. The executable business process definition is generated by generating a graphical process definition from each task flow corresponding to a use-case of the one or more use-cases and then converting each graphical process definition into the executable business process definition. Thereafter, the method includes representing the captured requirements to stakeholders in the form of navigational flow of user interface screens.

### FIELD OF INVENTION

The present invention relates to creation of prototypes for a software system. More particularly, the present invention provides for representing and validating the functional requirements of a software system.

### BACKGROUND OF THE INVENTION

Business organizations use streamlined processes for the management of business objectives. Managing business objectives includes defining and implementing a set of activities for providing products or services to clients. Business Process is a set of structured activities or tasks associated with a business, that produces a specific product or service. With increase in the complexity of business organizations and their related business processes in recent times there has been an increase in the use of software systems in defining and managing business processes.

An important aspect of software development related to the software systems for implementing business objectives of an enterprise is the creation of prototypes. Prototypes are preliminary versions of software systems that are used to demonstrate and validate functional requirements i.e. business features and functions of the system. Validation of requirements includes the process of checking in advance whether the specifications of the software system to be designed, have been correctly and adequately captured so that the designed system would be in accordance with the related functional objectives. For ensuring correct and adequate capture of software system specifications, requirements validation is performed by the stakeholders of the software system.

Functional requirements of a software system are the system's intended capabilities, business features, and interaction with users. The functional requirements can be captured using various methodologies such as use-cases, taskflow diagrams, functional screens, and workflow diagrams. The representation of software requirements for end users of the software system and the validation of the requirements by the end-users and other stakeholders is a necessary task to be done prior to the design and development of the software system.

Representation and validation of requirements of the software system at the initial stage of software development ensures an efficient process of development in which any changes or modifications in the software are made with minimum number of iterations. Validation by end users of software also ensures that the business objectives of the system are aptly captured. The validation process involves taking the stakeholders through the requirements artifacts such as use-case diagrams, taskflow diagrams, functional screens etc. including the screen level details in order to rapidly prototype the software system and reduce stakeholder review time.

Consequently, there is need for a system and a method for effectively representing the captured functional requirements of a software system to stakeholders for a prompt validation of the requirements.

### SUMMARY OF THE INVENTION

A method for representing and validating requirements of a software system is provided. The method includes capturing requirements of the software system. Further, the method includes converting the captured requirements into an executable business process definition. Thereafter, the method includes representing the captured requirements to stakeholders in the form of navigational flow of user interface screens. In an embodiment of the present invention, the software system is a system supporting a business process and implemented using software tools.

In various embodiments of the present invention, capturing requirements of the software system includes modeling one or more use-cases of the software system using text descriptions and taskflow models. Further, wireframe models corresponding to each use-case of the one or more use-cases are designed and each wireframe model is transformed into an HTML screen file. Thereafter, the taskflow models, the wireframe models, and the HTML screen files are stored in a software file. In an embodiment of the present invention, capturing requirements of the software system further includes specifying expressions in each use-case for navigating through the flow of tasks of the use-case.

In various embodiments of the present invention, converting the captured requirements into an executable business process definition includes generating a graphical process definition from each taskflow corresponding to a use-case of the one or more use-cases, converting each HTML screen file into a JSP file, generating one or more servlets for each user task in the graphical process definition and converting each graphical process definition into the executable business process definition.

In various embodiments of the present invention, generating a graphical process definition comprises converting each user task in a taskflow model to a user activity in the graphical process definition, converting each system task in a taskflow model to a system activity in the graphical process definition, transforming each branch in the taskflow model into an equivalent branch in the graphical process definition and converting each data field in the HTML screen corresponding to a user task, to an input parameter as well as an output parameter of the user activity corresponding to the user task. In an embodiment, the executable business process definition is a WS-BPEL standard based definition comprising invoke constructs and switch constructs in WS-BPEL standard based process definition.

In various embodiments of the present invention, converting each HTML screen file into a JSP file includes incorporating software code in the JSP file for setting the values for data fields of the HTML screens for the business parameter values of activities in the graphical process definition and tying each JSP to the corresponding user activity in the graphical process definition.

In various embodiments of the present invention, generating one or more servlets for each user task includes generating a request servlet for each user task to accept user actions on the task, generating a response servlet for each user task to respond to user actions on the task and tying each request/response servlet combination to the corresponding user activity in the graphical process definition. In an embodiment, the executable business process definition is deployed onto a process execution engine for executing the process definition. In an example, the JSP files and the one or more servlets are deployed onto a web server for access by a user. In another example, the use-case models, the workflow models, the taskflow models, and the HTML screen files are published onto a network folder of a computing device for access by a user.

In various embodiments of the present invention, representing the captured requirements to stakeholders includes accessing the HTML screen files in the HTML report corresponding to a use-case and demonstrating prototype screens of the use-case to stakeholders.

In various embodiments of the present invention, demonstrating prototype screens of the use-case includes displaying screens of the use-case taskflow on a web browser by the process execution engine based on access of the HTML screen files, waiting for user input for a task requiring user activity and displaying output prototype screens based on the order specified in the taskflow and the exemplary parameters input by the user. In an embodiment, the demonstration of prototype screens is achieved by the execution of the business process definition corresponding to the use-case taskflow by the process execution engine. In an example, the executable business process definition is a BPML standard based definition

In various embodiments of the present invention, the system for representing and validating the requirements of a software system includes a requirements capture module configured to capture the requirements of the software system in the form of one or more use-cases, taskflow models, and wireframe models. Further, the system includes an executable process modeler configured to generate graphical process definitions, an executable business process definition, JSP files and servlets corresponding to each use-case and deploy the JSP files and the servlets onto a web server. Moreover, the system includes a process execution engine configured to execute the business process definition and a web server configured to run the servlets and JSP files corresponding to each user task of the use-case.

### BRIEF DESCRIPTION OF THE ACCOMPANYING DRAWINGS

The present invention is described by way of embodiments illustrated in the accompanying drawings wherein:

FIG. 1 illustrates a system for prototyping a software system by capturing, representing, and validating the functional requirements of the software system;

FIG. 2 illustrates a flow diagram depicting the processing steps used by a business analyst for capturing the requirements of a software system;

FIG. 3 illustrates the description of a taskflow model for an exemplary use-case of a software system implementing a business objective;

FIG. 4 illustrates a sample wireframe model for the “select a product” event in the taskflow model of FIG. 3;

FIG. 5 illustrates a flow diagram depicting the steps for generating a comprehensive user-interactive module as a prototype, from the captured requirements of a software system; and

FIG. 6 illustrates a flow diagram for depicting the steps for representation and validation of requirements of the software system.

### DETAILED DESCRIPTION OF THE INVENTION

A system, method and computer program product for prototyping of software systems is provided. The present invention is more specifically directed towards representing and validating requirements of a software system. An exemplary scenario in which the present invention may be used is a business function implemented by a software system. For carrying out efficient software design, representing and validating requirements of the software system early in the design cycle ensures prompt modification of system requirements at an early stage, thereby minimizing design and development turnaround time.

In an embodiment of the present invention, the system, method and computer program product disclosed provides capturing the requirements of the software system using industry standard software models such as use-case models, taskflow models, wireframe models and Hyper Text Markup Language (HTML) screen flows.

In another embodiment of the present invention, the system, method and computer program product disclosed provides converting the captured software system requirements into an executable process represented in a standard execution process definition standard such as a Web Services Business Process Execution Language (WS-BPEL).

In yet another embodiment of the present invention, the system, method, and computer program product disclosed provides for representation of requirements of the software system to stakeholders in the form of a prototype implemented as an executable process model. The prototype enables navigation of screens of the executable software system, by a business analyst and validation of the requirements by the stakeholders during the review stage.

In yet another embodiment of the present invention, the system, method, and computer program product disclosed provides for input of exemplary parameters to the prototype screens of the executable process model during the requirements representation phase in order to verify that the captured system requirements conform to the intended specifications.

Hence, the present invention enables a time-efficient validation of functional requirements of a software system. The present invention also enables changes in the software design in the requirements phase based on inputs from the stakeholders.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purpose of clarity, details relating to technical material that is known in the technical fields related to the invention have been briefly described or omitted so as not to unnecessarily obscure the present invention.

The present invention would now be discussed in context of embodiments as illustrated in the accompanying drawings.

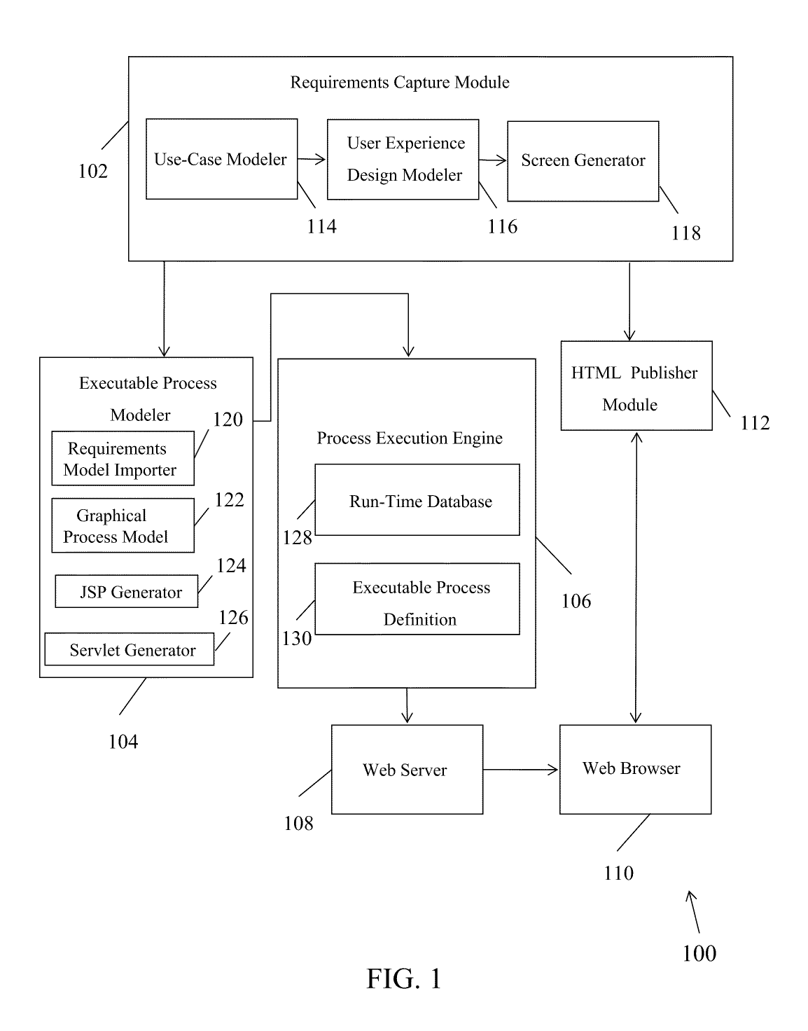

FIG. 1 illustrates a system 100 for capturing, representing, and validating the requirements of a software system. In various embodiments of the present invention, the “software system” is a system supporting a business process and implemented using software tools. A business process may be any process for implementing a business objective of an enterprise. Business objectives include activities related to business functions such as product development, sales, marketing, manufacturing, logistics, supply, customer interaction and the like. The system 100 comprises a Requirements Capture Module 102, an Executable Process Modeler 104, a Process Execution Engine 106, a Web Server 108, a Web Browser 110 and an HTML Publisher Module 112. The Requirements Capture Module 102 is a build-time program that provides multiple graphical tools to a business analyst for defining the requirements of a “software system”. The requirements of the “software system” are the needs and conditions to be met by the software system. The Requirements Capture Module 102 comprises a use-case modeler 114, a user experience design modeler 116, and a screen generator 118. The requirements of the “software system” are captured by the business analyst using software tools such as use-case diagrams, use-case descriptions, workflow diagrams, taskflow diagrams, and functional screens. The use-case modeler 114 may be used by the business analyst to model use-case descriptions. Use-cases are representations of the “software system” to deliver a specific functionality. A use-case specifies actions in a sequence (including their variants) that the “software system” would perform to yield an observable result of business value to a user of the business process. Examples of use-case include drafting documentation such as text descriptions of scenarios of interaction between the users and software modules of the “software system”, descriptions of scenarios of interaction between the software modules of the “software system” and other systems, descriptions of tasks that the “software system” is expected to perform and the like. In an embodiment of the present invention, in the context of a software system for purchase order management, the use-case for “placing purchase orders” can be specified by text descriptions of scenarios of interaction between the users and software modules of the system and by text descriptions of system tasks. Examples of the text descriptions include, “select the option to place order” (user task), “prompt the user to select a product from the list” (system task), “select a product” (user task), “prompt the user to enter quantity of product” (system task), “enter the quantity” (user task), “validate the quantity” (system task), “display error message” (system task), “enter corrected quantity” (user task), “ask for user confirmation” (system task), and “confirm order” (user task). In an embodiment of the present invention, the business analyst models the use-cases of the “software system” by use-case diagrams in the use-case modeler 114.

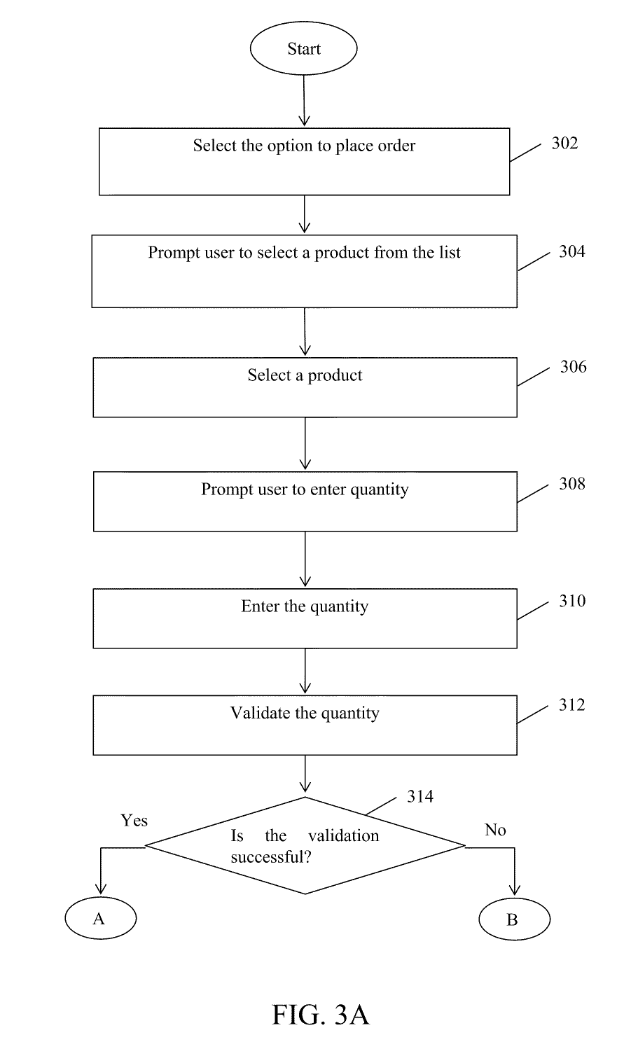

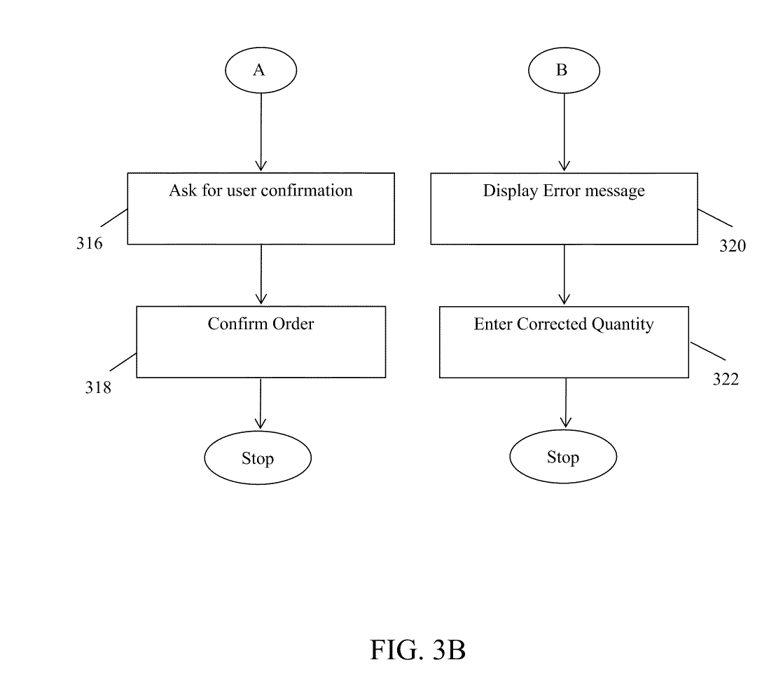

The user experience design modeler 116 is a software module used by the business analyst to design user interfaces for use-cases modeled in the use-case modeler 114. In an embodiment of the present invention, the user interfaces are wireframe models based on taskflow models corresponding to use-case descriptions. For a particular use-case, the business analyst first designs a taskflow model. A taskflow model is a flow diagram that depicts the flow of events in a use-case through a graphical mode. The flow of the events are depicted in the taskflow model by depicting a constant transfer of control between the user and the “software system” corresponding to scenarios of interaction between the users and software modules of the “software system” described in the use-case. A method for creating a taskflow model includes using standard workflow notations and indicative symbols for depicting the flow of tasks associated with a use-case. Standard workflow notations are graphical notations for specifying business processes commonly used in the industry. An example of a standard workflow notation may include an inclusive OR workflow notation that denotes one or more parallel paths to be taken corresponding to a task. An example of an indicative symbol may include a symbol for specifying whether a task is a user task or a system task. Taskflow models are illustrated in the US Patent Application Publication No. 20060174222 incorporated herein by reference for all purposes. Processing steps for describing an exemplary taskflow model corresponding to the “placing purchase orders” use-case is illustrated and described in conjunction with the description of FIG. 3.

For each user task in the taskflow model created corresponding to a use-case, the business analyst then creates a wireframe model as the screen for the user task. A wireframe model is a visual representation of the screen for user interaction of the user task. In an embodiment of the present invention, a wireframe model may be a visual representation and is not functionally usable. The wireframe model organizes screen level elements with placeholders for content and data, navigational elements, and controls. The output of the user experience design modeler 116 is a taskflow model and a set of wireframe models, corresponding to the requirements of the “software system” described by the use-case description in the use-case modeler 114, for the use-case. The screen generator 118 is a plug-in component to the requirements capture module 102 that transforms the wireframe model into a user interface screen. In various embodiments of the present invention, examples of screen formats that are generated by the screen generator 118 include, but are not limited to, Hyper Text Markup Language (HTML) screens. HTML screens are web compatible screens that can be shared across an IP based network such as the Internet. The screen generator 118 is a build-time program that uses a template-based document transformation or generation approach as implemented in an open-source templating engine. In an embodiment of the present invention, the screen generator 118 may be implemented using Apache Velocity. In various embodiments of the present invention, the user interface screen generated by the screen generator 118 is an HTML screen that includes screen layouts and controls conforming to the specifications of the wireframe model.

The Executable Process Modeler 104 is a build-time program that provides a facility to model business processes in a definition form that makes the processes executable by computer systems. In an embodiment of the present invention, the Executable Process Modeler 104 provides Graphical User Interface (GUI) resources to a user through which the user can model a business process as an ordered sequence of activities. The Executable Process Modeler 104 includes a requirements model importer 120, a Java Server Pages (JSP) Generator 124, and a servlet generator 126. The requirements model importer 120 imports use-case descriptions, taskflow models, wireframe models, and user interface screens generated in the Requirements Capture Module 102. The requirements model importer 120 generates a graphical business process definition by converting each task flow into a graphical process model 122. The requirements model importer 120 uses a general purpose modeling language including graphical notation techniques for modeling the graphical business process definition. An example of the general purpose modeling language may be Unified Modeling Language (UML). In an embodiment of the present invention, the requirements model importer 120 uses activity diagrams in which each task described in the taskflow model is converted to an activity in the graphical process model 122. The activity diagram presents step-by-step operations corresponding to the taskflow model. The JSP generator 124 is a software component for generating Java Server Pages. Java Server Pages is a Java technology used for generating dynamic markup language documents such as HTML, Extensible Markup Language (XML) in response to a user request. The JSP generator 124 takes as input HTML screens generated by the screen generator 118. Each HTML screen is then converted into a JavaServer Page (JSP) by the JSP generator 124. The generated JSP for a screen includes Java code for setting the values of the data fields of the HTML screens for the business parameter values of activities in the graphical process definition. The Servlet Generator 126 is a software component for generating Servlets. A Servlet is a Java technology for handling request-response interactions involving a web application user and the web application running in the web server. The Servlet Generator 126 generates request and response servlets for each user activity of the graphical process model 122. Each servlet generated by the Servlet Generator 126 would, at run-time, accept actions from user and respond to the user's action for the user activity corresponding to that servlet.

In an embodiment of the present invention, the graphical process model 122 generated by the requirements model importer 120 is converted by the Executable Process Modeler 104 into a Web Services-Business Process Execution Language (WS-BPEL) file. WS-BPEL is an XML based language used by organizations to describe their business processes in a standard manner so that tasks can be shared in a distributed computing environment using web services and to make the processes executable. XML is an open standard for exchanging structured documents, data and for creating customized markup languages. WS-BPEL can be extended to also include provisions for specifying and describing user activities of business processes. The WS-BPEL file is an executable business process definition corresponding to the graphical process definition. In various embodiments of the present invention, the business process definition generated by the Executable Process Modeler 104 may be in the form of a meta-language for modeling executable business processes such as Business Process Modeling Language (BPML). The executable business process definition is executable in a business process engine. In various embodiments of the present invention, the executable business process definition generated by the Executable Process Modeler 104 includes a WS-BPEL file along with attachments such as JSP files and Web-Services Description Language (WSDL) files. WSDL is an XML-based modeling language for describing services shared over a network such as web services. For example, WSDL files are used to describe details of the service interface for activities in the WS-BPEL process definition and for the WS-BPEL process itself

The Process Execution Engine 106 is an executable engine for executing business process definitions. The Process Execution Engine 106 is a run-time software component that executes business process definition described in the WS-BPEL file generated by the executable process modeler 104. The WS-BPEL file is first stored in a run-time database 128. The run-time database may be any relational database management system (RDBMS) including but not limited to MySQL, Oracle, DB2, FoxPro, MS Access, etc. Thereafter, the WS-BPEL file is executed by the Process Execution Engine 106. In an embodiment of the present invention, the WS-BPEL file is first converted into an internal executable process definition 130 by the Process Execution Engine 106 before executing it.

The Web Server 108 is a run-time program that acts as a server and serves web pages by executing JAVA servlets and the JSP files associated with the WS-BPEL file. In an embodiment of the present invention, the JSP files for the HTML screens and associated servlets of the executable business process definitions corresponding to use-cases of the “software system” are deployed onto the Web Server 108. At run-time, the Web Server 108 triggers the Process Execution Engine 106, through an initial servlet for a use-case, for running the executable process corresponding to the use-case. The HTML Publisher Module 112 publishes the entire requirements model of the software system in a report form such as HTML language using default templates and custom templates. The system models in the HTML report in the HTML publisher module include, but are not limited to, use-case models, taskflow models, workflow models, and HTML screens. In an embodiment of the present invention, the HTML report includes a page for each system model and links for navigation from one diagram to another. The HTML report is published in a network folder of a computing device for access by a business analyst, where the computing device is operatively coupled to the Web Server 108. A computing device may be any device for processing instructions and for storing and organizing data for easy access.

The Web Browser 110 renders the HTML web pages generated by the JSP files and the HTML web pages that are accessed by the business analyst in the HTML report published by the HTML publisher module 112. The Web Browser 110 may be any browser known in the art, such as, Internet Explorer, Mozilla Firefox, and the like. In an embodiment of the present invention, the business analyst walks the stakeholders through the HTML report via the Web Browser 110. The pages accessed in the HTML report include system models starting from higher-level models like graphical process definitions down to lower-level models like use-case models or use-case descriptions. While accessing the use-case descriptions, HTML screens corresponding to each use-case are rendered on the Web Browser 110 by the Web Server 108 in the task order specified in the use-case's task flow so that the business analyst is able to represent the requirements of the “software system” to the stakeholders. The HTML screens are displayed as a result of executing servlets and JSP files corresponding to the use-case model by the Web Server 108 under the direction of the executing process in the Process Execution Engine 106.

In various embodiments of the present invention, the business analyst can, at design-time, enter exemplary parameter values corresponding to each data field that is of list type in the wireframe screens of the use-case. In an exemplary embodiment, if the business functionality involves receiving and processing orders for wireless phones, while designing the wireframe model for the “select a product” user task in the use-case, the business analyst enters “Wireless Phones” in the list for “phone” data field of the wireframe model and corresponding “model number” in the list for “model number” data field of the wireframe model. At run-time, selecting the type of wireless phone such as “CDMA” and model number such as “M23”, would result in the subsequent screens of the use-case displaying the same value for these two fields.

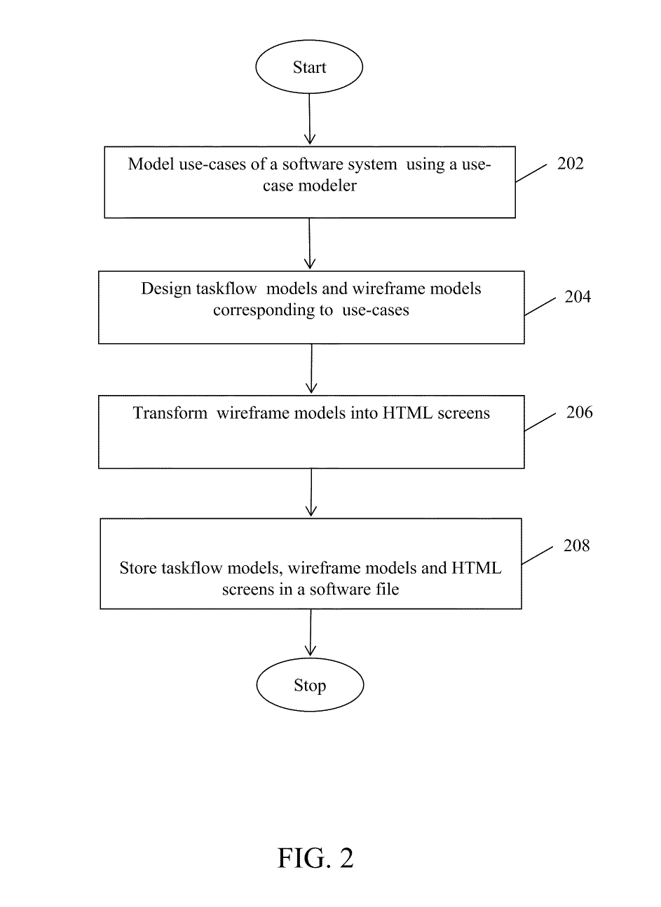

FIG. 2 illustrates a flow diagram depicting the processing steps used by a business analyst for capturing the requirements of a software system. At step 202, a business analyst captures the requirements of the “software system” by modeling use-cases of the business functionalities to be supported by the software system. Use cases are a comprehensive set of scenarios of interaction between the users and software modules of a software system. Use-cases also provide scenarios for interaction between the software modules of the system and any other system. An important step in specifying the use-cases of a specific business functionality to be implemented by a “software system” includes identifying the tasks of the specific business function. In an exemplary embodiment, a Business Process for a Pharmaceutical Enterprise conducting tests on medical samples for customers and providing reports might include creating and managing medical test projects. Creation and Management of medical test projects might include the following activities:

### Defining a Project Team

### Defining Project Milestones

Configuring study for a project i.e. Selecting the tests to be done on a medical sample. Each of the above activities might include one or more tasks. Configuring study for a project might include the following tasks: Select test panels from the base set and add to study (User Interactive Task), Retrieve test panels from the base set (System Task), and Retrieve list of existing studies. The use-cases in the above example are representation of the flow of tasks. In an embodiment of the present invention, standard workflow notations may be used to depict the flow of tasks. An example of a standard workflow notation may include an inclusive OR workflow notation that denotes one or more parallel paths to be taken corresponding to a task.

The modeled use-cases include taskflow models in conjunction with graphical notations describing user-system interactions corresponding to the flow of events. In an embodiment of the present invention, the business analyst can specify validation rules for a system task. Business rules corresponding to a system task can also be specified which may indicate some computation or processing logic for the task that the system would follow. The processing logic may include a logic expression for validating a system task. For example, in the use-case for software system for “processing purchase orders” stated in the description of FIG. 1, rules can be specified for validating the quantity of products by the business analyst corresponding to the system task “validate the quantity”. The business analyst can define a condition expression for branching in the taskflow. For instance, “validated=false” can be a condition expression denoting that the quantity cannot be validated and “validated=true” can be a condition expression denoting that the quantity can be validated. Based on the result of the condition expression, the use-case implements the subsequent task. For Example, in case of “validated=false” condition expression being determined to be valid, the software system executes the system task “display error message”. In another instance, in case of “validated=true” condition expression being determined to be valid, the software system executes the system task “ask for user confirmation”. In various embodiments of the present invention, the rules and expressions specified by a business analyst are XML Path Language (XPath) expressions. XML Path Language is a language for selecting paths (branches) in a tree representing an XML document. In an example, the XPath expressions may involve assigning a value to a business field after performing a computation. At step 204, the business analyst designs taskflow models and wireframe models corresponding to the use-cases modeled at step 202. In an embodiment of the present invention, each taskflow model is created to elaborate and describe each use-case. Wireframe models are used to elaborate the user interaction tasks in a use case. The screen for each user interaction step in a use-case is designed as a Wireframe model. Thereafter, at step 206, the wireframe models are converted into HTML screens. HTML screens are functionally usable visual descriptions of wireframe models which can be accessed by a business analyst. In an embodiment of the present invention, an HTML screen generator has a template defined that specifies how each element in the wireframe model needs to be converted into the corresponding element of the HTML screen. In an embodiment of the present invention, the taskflow models, wireframe models and HTML screens are then stored in a software file by the business analyst at step 208, for later use in generating a user-interactive business software prototype.

FIG. 3 illustrates the description of a taskflow model for an exemplary use-case of a business process. As stated in the description of FIG. 2, the methodology for capturing the requirements of business functionalities implemented by a software system includes using taskflow models. For an exemplary use-case: a process for “processing purchase orders”, the steps (events) describing the order in which the tasks for processing purchase orders are carried out and are enumerated as follows: At step 302, the software system displays a screen to the user for selecting an option for placing an order. In an embodiment of the present invention, the purchase orders processed are orders for wireless products. At step 304, the system displays a drop-down list and prompts the user to select a product from the list. In an example, the drop-down list is a list of model numbers of wireless phones. At step 306, the user selects a wireless product from the list displayed. At step 308, the system prompts the user to enter a value for the quantity to be ordered. At step 310, the user enters the order quantity of the wireless product. At step 312, the system validates the quantity of the wireless product entered by the user. Validation of quantity of the wireless product includes determining whether the user-specified quantity of the wireless product is available. Thereafter, at step 314, it is determined if the validation is successful. If it is determined that the validation has been successful, then at step 316, the system asks for user confirmation, and at step 318 the order is confirmed. However, if it is determined that the validation has been unsuccessful, then at step 320, the system displays an error message and at step 322, the user enters the corrected quantity.

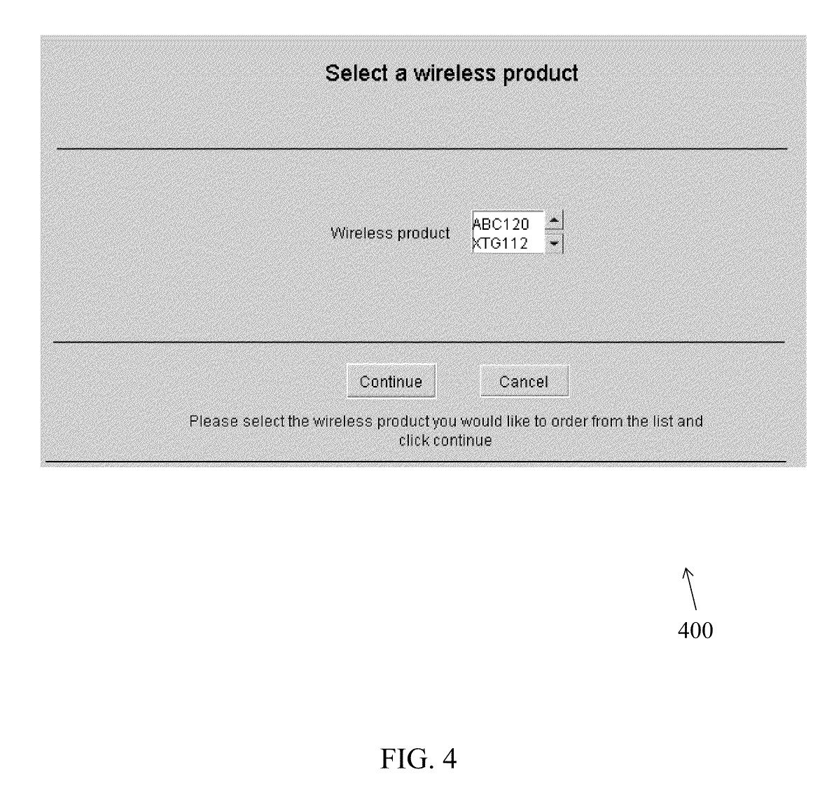

FIG. 4 illustrates a sample wireframe model for the “select a product” event in the taskflow model of FIG. 3. The wireframe model shown in the figure is a user interface screen for the user interaction event “select a product” for the use-case “processing purchase orders” described in conjunction with FIG. 3. The wireframe model includes display and content for variant data as well as display and content for invariant data. The display and content for variant data includes a field containing a list of sample values of various models for a wireless product selected by a user. The wireframe model provides for a facility for selecting one or more of the models. For example, the sample models as shown in the figure are: “ABC 120” and “XTG 112”. The display and content for invariant data includes a scroll bar for scrolling through the list of sample values, a user interface button for continuing on to the next event of the use-case (“Continue”), and a user interface button for cancelling the display of sample models for the selected product.

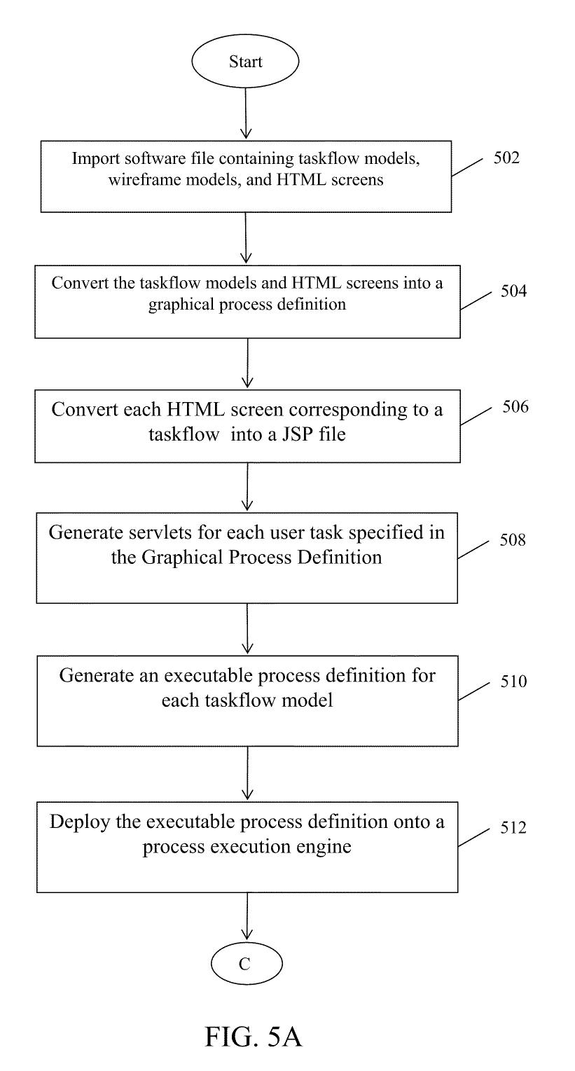

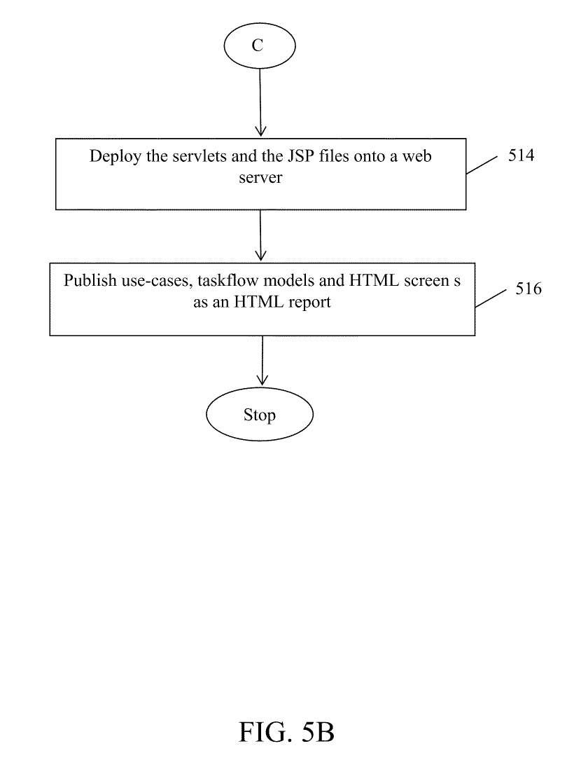

FIG. 5 illustrates a flow diagram depicting the steps for generating a comprehensive user-interactive module, as a prototype, from the captured requirements of a software system. As specified in the description of FIG. 2, the business analyst stores taskflow models, wireframe models, and HTML screens corresponding to a use-case in a software file. At step 502, the software file is imported by the business analyst. At step 504, the taskflow models and the HTML screens corresponding to the use-case are converted into a graphical process definition. The graphical process model is a general-purpose model including activity diagrams corresponding to the use-case. Each event in the taskflow model is converted into an activity in the graphical process model. For example, a system event in the taskflow model becomes a system activity, a user event becomes a user activity, a branch becomes a branch (or a decision point), and each data field (i.e. variable) in the HTML screen becomes an input parameter field and output parameter field of the activity in the graphical process model. In an embodiment of the present invention, the input and output parameter fields are used as fields for accepting and providing exemplary parameters for software requirements validation. For the tasks that have rules specified in the form of XPath expressions in the use-case model, sub-process activities corresponding to the task are created and listed in the graphical process model. Conditional expressions in the use case are converted into a branch activity in the graphical process model and the expression is put as the visible value of the branch content. In an example, for the system task “validate the quantity” for the “processing purchase orders” use-case described in FIG. 2, branch activities for the condition expressions “validated=false” and “validated=true” are included in addition to system activities corresponding to the system tasks. At step 506, each HTML screen corresponding to a taskflow model is converted into a JSP file. Each JSP file is attached to a user activity in the graphical process model. The JSP file includes JAVA code for setting the values of data fields and for displaying the data field values in response to a user activity. For example, in the use-case for a software system for “processing purchase orders”, the event “select a product” (user task) in the taskflow model is specified by a JAVA code to display a drop-down list for the user to select a product. At step 508, servlets are generated for each user task in a JSP file. In an embodiment of the present invention, one request servlet and one response servlet is generated for each user event i.e. for each activity in the graphical process model.

At step 510, an executable process definition is generated for each of the taskflow models imported at step 502. In an embodiment of the present invention, the executable process definition is in WS-BPEL format. The WS-BPEL file includes software constructs for describing activities in the graphical process model such as, constructs for: user actions (activities such as invoke, receive), conditional branching (switch), split and merge (flow), assignments to variables and expressions. Further, the WS-BPEL file may include extended software constructs for allowing specification of a user activity such as human interaction involving user interface screens. In an exemplary embodiment, each user activity and system activity in the graphical process model is converted into an <invoke> construct in WS-BPEL. For example, for the “select a wireless product” event described in the wireframe model of FIG. 4, the <invoke> construct is defined as follows:

a. <invoke correlate=“product”
b. inputVariable=“Select_a_product.InParam”
locate=“http://localhost:8080/peas/PlaceOrder/
Select_a_product_RequestServlet”
mode=“Manual” name=“ Select_a_product” operation=“”
c. outputVariable=“ Select_a_product.OutParam”
/>
<variables>
d. <variable messageType=“ Select_a_productInParams”
name=“Select_a_product.InParam”/>
</variables>
<wsdl:message name=“ Select_a_productInParams”>
e. <wsdl:part name=“product” type=“xsd:string”/>
</wsdl:message>

In the above example, the product field appears as a parameter for the activity. Each branch activity in the model is converted into a <switch> construct in WS-BPEL.

In various embodiments of the present invention, a sub-process activity described in the graphical process model for a use-case is executed in the WS-BPEL file using an <invoke> construct. A sub-process in the WS-BPEL process definition is an ordered sequence of system activities where each system activity represents a step of an XPath expression (condition expression) for the sub-process activity. The <invoke> construct includes details for the sub-process to be invoked. In an example, the details for the sub-process are denoted in the portType attribute of the <invoke> construct. Thus, sub-processes corresponding to a system task are described as executable process definitions in the WS-BPEL file. In an embodiment of the present invention, each system activity in a sub-process is implemented in WS-BPEL definition by an <assign> construct with the corresponding XPath expression appearing in the “expression” attribute of the <assign> construct. In an example, a sub-process can have other sub-processes recursively present under it depending on the structure of the general expressions coded for the system task by the business analyst. Thereafter, at step 512, the executable process definition is deployed onto a process execution engine, and at step 514, the servlets and JSP files associated with the graphical process model are deployed onto a web server.

At step 516, the use case models, taskflow models, and the HTML screens are published using an HTML publisher module. In an embodiment of the present invention, the HTML screen files are in the form of an HTML report including a page for each system model (graphical process models and taskflow models) and links for navigation from one type of model to another. The HTML report may be published by the HTML publisher module onto a network folder of a computing device which is operatively coupled to a web server. The business analyst can access the HTML report through a web browser installed in the same computer in order to demonstrate and validate software system requirements.

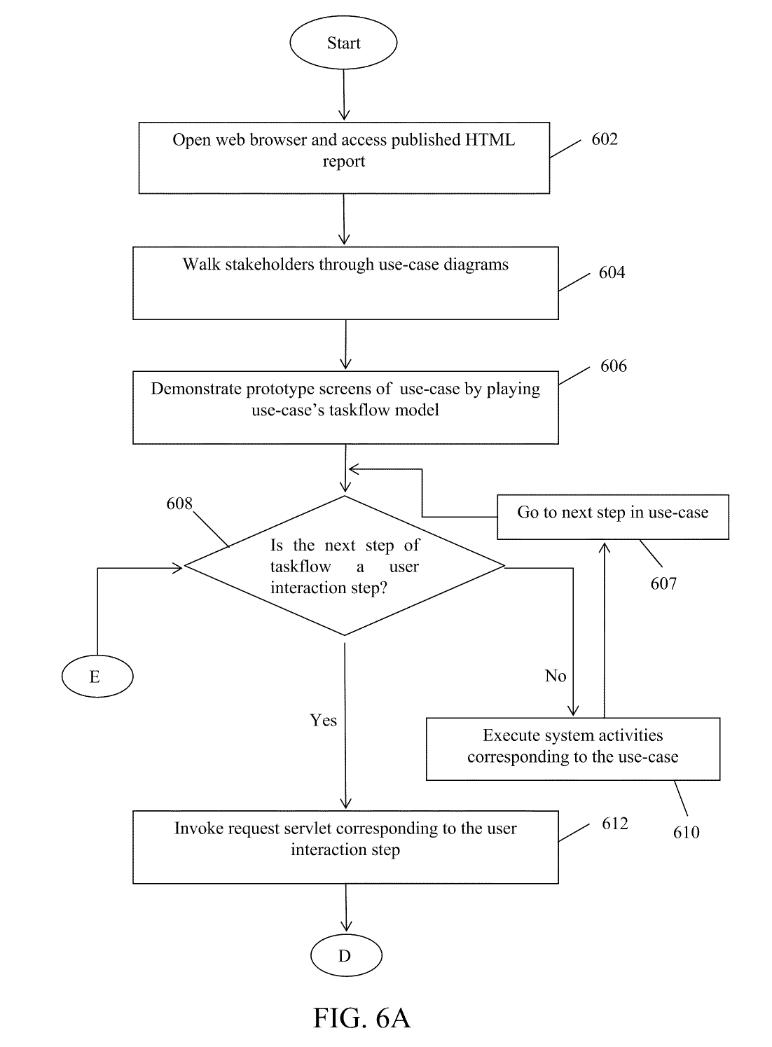

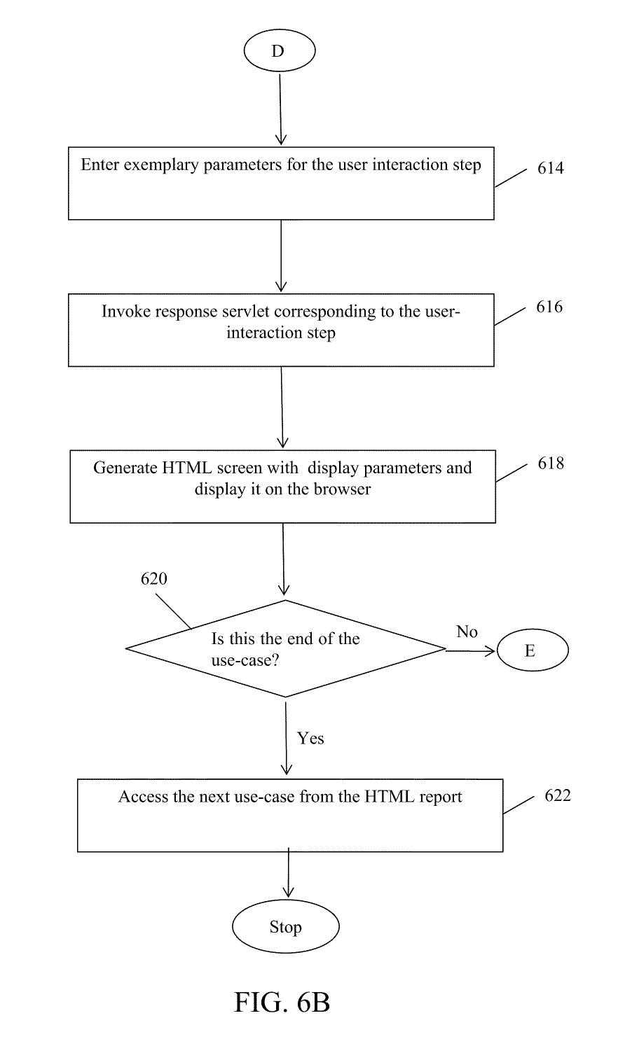

FIG. 6 illustrates a flow diagram for depicting the steps for representation and validation of requirements of the software system. The representation of requirements to stakeholders and validation of the requirements is a streamlined approach for ensuring detection of variance between the system's captured functionality requirements and its intended functionality. At step 602 the business analyst opens a web browser. The web browser is in communication with the web server containing the HTML report for a use-case of a business process implemented by the software system. The business analyst accesses the HTML report for the use-case and demonstrates them to stakeholders for review at step 604. Examples of stakeholders may include, but are not limited to, users, manufacturers, dealers, and official reviewers of the software system. The business analyst first demonstrates a higher level model such as business scenario model. Thereafter, the business analyst browses through use-cases corresponding to a specific business function. At step 606, the business analyst displays prototype screens of the use case. The screens are then viewed by the web browser. In various embodiments of the present invention, the business analyst clicks on the pages of the HTML report for the use-case to display the prototype screens of the use-case. The prototype screens are user-system and system-system interaction scenarios played out as per the use-case task flow by the web server on direction by a process execution engine. Clicking on an HTML report page results in system control being transferred to a servlet in the web server for the taskflow and the servlet initiates process execution in the process execution engine.

At step 608, the software system determines if the next step of the taskflow is a user-interaction step. In the event of the next step not being a user-interaction step, at step 610, the process execution engine executes the system activities in the business process definition corresponding to the use-case. Thereafter, at step 607, the execution control proceeds to next step in use-case. However, if at step 608, it is determined that the next step is a user-interaction step, the execution control passes on to a request servlet in the web server at step 612. The request servlet passes control to the JSP for the user activity that displays the user-interaction screen on the web browser. Thereafter, at step 614, the user-interaction HTML screen prompts the business analyst to enter exemplary parameters pertaining to the use-case. For example, in the “processing purchase orders” use-case stated in the description of FIG. 3, for the user activity “select a product”, the business analyst selects a product from the list of model numbers displayed and clicks on a “submit” button. At step 616, a response servlet corresponding to the user activity that displayed the user-interaction screen is invoked. The response servlet receives the input by the business analyst. At step 618, the response servlet displays an HTML screen in response to the exemplary parameters entered by the business analyst. For example, the HTML screen may be a screen displaying the selected product and providing the user to enter “quantity of the product” selected. Thereafter, the response servlet indicates through an API function to the process execution engine to resume process execution and move to the next activity. Thus, the process execution engine executes the system activities by itself until it reaches a user activity and then waits for user input before proceeding to the next activity. At step 620, it is determined by the system whether the flow has reached the end of the use-case.

If it is determined that all the steps of the use-case have been executed, then at step 622, the next use-case is accessed by the business analyst from the HTML report. Otherwise, the system control is transferred to step 606, and the process execution of the subsequent steps is carried out sequentially.

The present invention may be implemented in numerous ways including as a system, a method, or a computer readable medium such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

What is claimed is:

1. A method for representing and validating requirements of a software system, the method comprising the steps of:
capturing requirements of the software system;
converting the captured requirements into an executable business process definition; and
representing the captured requirements to stakeholders in the form of navigational flow of user interface screens.

2. The method of claim 1, wherein the software system is a system that meets functional requirements provided by a business.

3. The method of claim 1, wherein the software system is a system that is implemented using one or more software applications to support a business process.

4. The method of claim 1, wherein the step of capturing requirements of the software system comprises the steps of:
modeling one or more use-cases of the software system using text descriptions and taskflow models, wherein a taskflow model lists one or more tasks corresponding to a use-case;
designing wireframe models corresponding to each use-case of the one or more use-cases, wherein a wireframe model is a visual representation of user interaction of a user task of the one or more use-cases;
transforming each wireframe model into an HTML screen file, wherein the HTML screen file is a user-interactive, functionally usable visual representation of the user task; and
storing the taskflow models, the wireframe models, and the HTML screen files in a software file.

5. The method of claim 4 further comprising the step of specifying expressions in each use-case for navigating through the flow of tasks of the use-case, wherein the expressions include arithmetic expressions, and conditional expressions for specifying and selecting branches in the flow of tasks corresponding to the use-case.

6. The method of claim 5, wherein the step of converting the captured requirements into an executable business process definition comprises the steps of:
generating a graphical process definition from each taskflow corresponding to a use-case of the one or more use-cases;
converting each HTML screen file into a JSP file;
generating one or more servlets for each user task in the graphical process definition; and
converting each graphical process definition into the executable business process definition.

7. The method of claim 6, wherein the step of generating a graphical process definition comprises the steps of:
converting each user task in a taskflow model to a user activity in the graphical process definition;
converting each system task in a taskflow model to a system activity in the graphical process definition;
transforming each branch in the taskflow model into an equivalent branch in the graphical process definition; and
converting each data field in the HTML screen corresponding to a user task, to an input parameter as well as an output parameter of the user activity corresponding to the user task.

8. The method of claim 7, wherein the executable business process definition is a WS-BPEL standard based definition comprising invoke constructs and switch constructs in WS-BPEL standard based process definition, wherein each invoke construct corresponds to a user task in the corresponding use-case and each switch construct corresponds to a branch task in the corresponding use-case.

9. The method of claim 8, wherein each system activity that has one or more expressions specified in it, is transformed to an invoke construct in the WS-BPEL standard based definition, further wherein the invoke construct invokes a sub-process at prototype run-time.

10. The method of claim 9, wherein each sub-process is generated as a WS-BPEL standard based definition, further wherein the each sub-process comprises:
one or more assign constructs, wherein each assign construct represents each step in the expression specified in the system task; and
an invoke construct corresponding to a structured step in the expression specified in the system task, wherein the invoke construct represents a lower-level sub-process present under the each sub-process, further wherein the lower-level sub-process comprises similar lower-level sub-processes generated recursively.

11. The method of claim 6, wherein the step of converting each HTML screen file into a JSP file comprises the steps of:
incorporating software code in the JSP file for setting the values for data fields of the HTML screens for the business parameter values of activities in the graphical process definition; and
tying each JSP to the corresponding user activity in the graphical process definition.

12. The method of claim 6, wherein the step of generating one or more servlets for each user task comprises the steps of:
generating a request servlet for each user task to accept user actions on the task;
generating a response servlet for each user task to respond to user actions on the task; and
tying each request/response servlet combination to the corresponding user activity in the graphical process definition.

13. The method of claim 12, wherein the JSP files and the one or more servlets are deployed onto a web server for access by a user.

14. The method of claim 7, wherein the executable business process definition is deployed onto a process execution engine for executing the process definition.

15. The method of claim 7, wherein the use-case models, the workflow models, the taskflow models, and the HTML screen files are published onto a network folder of a computing device for access by a user, wherein the computing device is operatively coupled to the web server.

16. The method of claim 7, wherein the step of representing the captured requirements to stakeholders comprises the steps of:
accessing the HTML screen files in HTML report corresponding to a use-case; and
demonstrating prototype screens of the use-case to stakeholders.

17. The method of claim 16, wherein the step of demonstrating prototype screens of the use-case comprises the steps of:
displaying screens of the use-case taskflow on a web browser by the process execution engine based on access of the HTML screen files;
waiting for user input for a task requiring user activity; and
displaying output prototype screens based on the order specified in the taskflow and the exemplary parameters input by the user.

18. The method of claim 17, wherein the demonstration of prototype screens is achieved by the execution of the business process definition corresponding to the use-case taskflow by the process execution engine.

19. The method of claim 7, wherein the executable business process definition is a BPML standard based definition.

20. A system for representing and validating the requirements of a software system, the system comprising:
a requirements capture module configured to capture the requirements of the software system in the form of one or more use-cases, taskflow models, and wireframe models;
an executable process modeler configured to:
generate graphical process definitions corresponding to the one or more use-cases;
generate an executable business process definition for each use-case of the one or more use-cases;
generate JSP files and servlets corresponding to each use-case;
deploy the business process definition for execution onto an execution engine; and
deploy the JSP files and the servlets onto a web server.
a process execution engine configured to execute the business process definition; and
a web server configured to run the servlets and JSP files corresponding to each user task of the use-case.
